(19) United States
(12) Patent Application Publication
(10) Pub. No.: US 2018/0340083 A1
(43) Pub. Date: Nov. 29, 2018

(54) METAL DISPERSION WITH INCREASED STABILITY

(71) Applicant: CLARIANT INTERNATIONAL LTD., Muttenz (CH)

(72) Inventors: Alexander RÖSCH, Mainz (DE); Carsten SCHÄFER, Frankfurt (DE)

(73) Assignee: CLARIANT INTERNATIONAL LTD., Muttenz (CH)

(21) Appl. No.: 15/771,757

(22) PCT Filed: Oct. 12, 2016
(86) PCT No.: PCT/EP2016/074424

§ 371 Date: Apr. 27, 2018

(30) Foreign Application Priority Data
Oct. 30, 2015 (DE) 10 2015 221 349.8

(51) Int. Cl. C09D 5/24; B01J 13/00; C08L 33/06; B22F 1/00

(52) U.S. Cl. CPC C09D 5/24; B01J 13/0034; B82Y 40/00; C08L 33/06; B22F 1/0022; B01J 13/0043

(57) ABSTRACT

The invention relates to metal dispersions comprising 50 to 80 wt % of silver nanoparticles, 15 to 45 wt % of water and a dispersant, wherein the dispersant comprises copolymers comprising 1-99 wt % of structural units of formula (1),

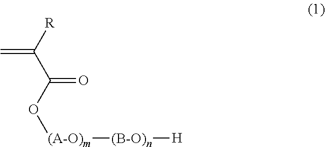

where
R is hydrogen or C₁-C₆ alkyl,
A is C₂-C₄ alkylene group and
B is C₂-C₄ alkylene group with the proviso that A and B are different and
m, n are each independently an integer of 1-200, and
1-99 wt % of structural units of formula (2),

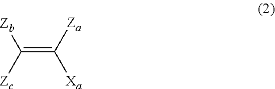

where
Xₐ is an aromatic or aliphatic radical having 1 to 30 carbon atoms which optionally comprises one or more, for example 1, 2, or 3, heteroatoms N, O and S,
Zₐ is H or (C₁-C₄)-alkyl,
Z_{b} is H or (C₁-C₄)-alkyl and
Z_{c} is H or (C₁-C₄)-alkyl.

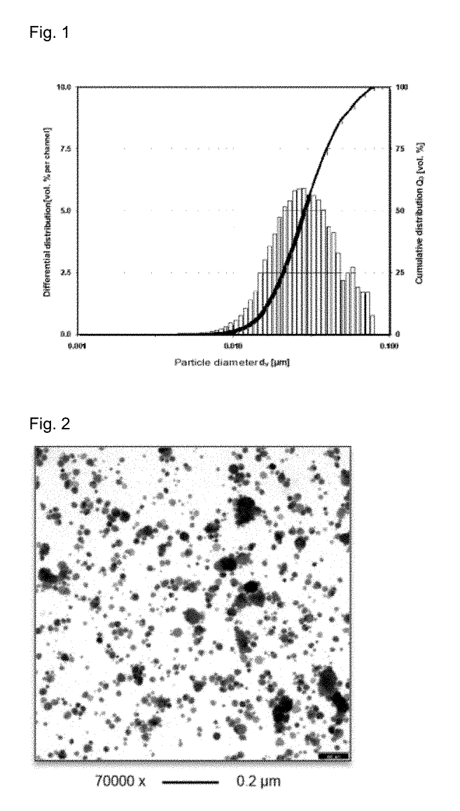

The present invention relates to the use of copolymers which stabilize metal particle sols having a metal particle content of 50 to 80 wt %.

In the context of the present invention the term metal particles comprehends nanoparticles and submicroparticles. In the context of the present invention nanoparticles are defined as particles smaller than 100 nm at least in one dimension. Microparticles are particles between 1 μm and 1000 μm in size in all three dimensions. Submicroparticles are defined as particles larger than 100 nm in all three dimensions and smaller than 1 μm in at least one dimension. A sol or colloid is a dispersion of nano- or submicroparticles in a liquid.

Important criteria for the properties and fields of application of nanoscale and submicroscale metal particles include mean particle size, particle size distribution, colloid-chemical stability of the dispersion and processing and physicochemical properties of the particles.

Various processes for producing metallic nanoparticles are disclosed in the prior art. One known principle is direct chemical reduction of dissolved metal ions in the liquid phase. Many variants of this method seek to produce colloid-chemically stable dispersions of metallic nanoparticles having a narrow particle size distribution and defined surface properties.

The term “colloid-chemically stable” is to be understood as meaning that the properties of the colloidal dispersion or of the colloids themselves hardly change during a typical storage time before the first application or during a pause between two production cycles. Thus for example no substantial aggregation or flocculation of the colloids which would have a negative effect on product quality should take place. The sedimentation/aggregation of particles is typically ascertained by determination of the solids content of the upper part of a dispersion. A severe decline in the solids content indicates low colloidal stability of the dispersion.

An essential constituent for the synthesis of nanoscale metal dispersions is the dispersing additive used. Said additive must be present in a sufficient amount to disperse the metal particles but should result in only minimal impairment of the function of the metals in a subsequent application and should therefore ideally be present in a low concentration. An excessively high coating of the surface may additionally negatively affect the physicochemical properties of the metal sols.

Metal dispersions find use especially in microelectronic components as conductors, semiconductors or for shielding electromagnetic fields. The metal particles must be applied in finely dispersed form without first agglomerating and should form an uninterrupted layer after a curing process. Particularly advantageous for this curing process is a) expending as little energy as possible or b) reducing the curing time. This is intended to allow use of temperature-sensitive substrates.

Water-dispersible metal dispersions are preferred over solvent-containing systems inter alia for safety reasons, e.g. due to avoidance of flash point. The use of highly concentrated metal dispersions is in this case desired for economic and technical reasons since this permits great freedom for further formulation.

The production of aqueous metal dispersions is extensively described in the literature.

Thus U.S. Pat. No. 2,902,400 (Moudry et al.) discloses the use of microscopic silver particles obtained by chemical reduction of silver nitrate with hydroquinone and tannic acid as disinfectant. For stabilization special gelatine products are selected and reacted in a batchwise procedure. A continuous synthesis with clearly defined polymeric dispersing assistants was not described. A removal of unconverted reactants or reaction products formed was not effected. The dispersed microparticles obtained in a concentration of 0.6 wt % were diluted to 1:50 000 with deionized water.

U.S. Pat. No. 2,806,798 describes a process for producing yellow colloidal silver sols for photographic applications. Polyethylene glycols or polypropylene glycols or glycerine are described as stabilizers in connection with polyvinyl alcohol, polyvinyl ester and acetals. Copolymers composed of (meth)acrylic monomers are not used in this document. The examples describe toxic hydrazine hydrate for reduction of various silver salts. Purification is effected by precipitation in acetone and redispersal in water. The thus obtained silver sol is embedded in photosensitive layers. This document does not go into the conductivity of sintered silver particles.

In U.S. Pat. No. 3,615,789 colloidal silver is used for color filter systems and photographic layers. Sulfonated diaminobiphenyls are described as flocculation aids and gelatine is used as a protective colloid. Both substance classes comprise sulfur and are therefore unsuitable as an additive for the production of pure silver compounds (formation of AgS). Production of the colloidal silver having a final weight fraction of silver of 1.3-4.2% is performed via a batch procedure and comprises a plurality of complex purification steps. However, there is no indication of the temperature dependence of the silver particles.

EP-A-1493780 addresses the synthesis of silver oxide nanoparticles and their conversion into metallic silver. The conductive composition comprises a particulate silver compound and a binder and optionally a reductant and a binder. Silver oxide, silver carbonate, silver acetate and the like are employed as the particulate silver compound. Ethylene glycol, diethylene glycol, ethylene glycol diacetate and other glycols are employed as the reductant. A fine powder of a heat-curable resin such as a polyvalent styrene resin or polyethylene terephthalate having an average particle diameter of 20 nm to 5 μm is employed as the binder. The particulate silver compound is reduced to elemental silver in the binder at temperatures above 150° C., which coalesce with one another. However, EP-A-1493780 does not disclose how highly concentrated aqueous dispersions of silver nanoparticles generate a conductive layer at temperatures below 150° C.

Ruy et al., Key Engineering Materials, Vol. 264-268 (2004), pages 141-142 teaches the synthesis of nanoscale silver particles using homopolymeric ammonium salts. Silver nitrate is transformed into elemental silver with sodium borohydride or hydrazine. This affords an aqueous not-more-than-10% silver dispersion with a particle size of <20 nm. This document gives no indication of storage stability and sintering behavior at low temperatures below 130° C.

U.S. Pat. No. 8,227,022 describes the production of aqueous dispersions of metallic nanoparticles in a two-stage process. For this purpose, in a first substep a dissolved metal salt is subjected to preliminary reduction with a water-soluble polymer and complete reduction with a reductant. In a second substep the nanoparticles are concentrated and redispersed by a second dispersant. The described production process was performed in small laboratory amounts and affords a silver dispersion having an Ag proportion of not more than 18%. The proportion of dispersant relative to silver was ascertained as 5.7% in the best case. The values reported in table 4 show that conductivity is generated even at relatively low temperatures above 60° C. This is a disadvantage since due to the waste heat in the printing process or the printing-mediated heating of the substrate such conditions lead to premature sintering of the metal particles and thus to failure of the machines used.

U.S. Pat. No. 8,460,584 describes a method whereby silver nanoparticles may be prepared using low molecular weight (C₄-C₂₀ carbon chain length) carboxylic acids. After precipitation of the particles said particles may be dispersed in organic solvents (toluene) and oleic acid. An ecologically sound dispersion in water is not described. To determine electrical conductivity the product is applied to a glass sheet and sintered at a temperature of 210° C. Conductivity is reported as 2.3 E04 S/cm (=2.3 E06 S/m).

A method for producing concentrated nanoscale metal oxide dispersions and the further use thereof in the production of nanoscale metal particles was described in WO 2007/118669. Therein, metal oxides are reduced to elemental silver using formaldehyde. The metal particles are dispersed in the aqueous phase by addition of a dispersing assistant. The metal particle sols and the oxidic precursors thereto exhibit a high colloid-chemical stability due to the use of the dispersing assistant.

In one embodiment in WO 2007/118669 dispersing assistants are selected from the group comprising alkoxylates, alkylolamides, esters, amine oxides, alkyl polyglycosides, alkylphenols, arylalkylphenols, water-soluble homopolymers, random copolymers, block copolymers, graft polymers, polyethylene oxides, polyvinyl alcohols, copolymers of polyvinyl alcohols and polyvinyl acetates, polyvinylpyrrolidones, cellulose, starch, gelatine, gelatine derivatives, amino acid polymers, polylysine, polyaspartic acid, polyacrylates, polyethylenesulfonates, polystyrenesulfonates, polymethacrylates, condensation products of aromatic sulfonic acids with formaldehyde, naphthalenesulfonates, lignosulfonates, copolymers of acrylic monomers, polyethyleneimines, polyvinylamines, polyallylamines, poly(2-vinylpyridines) and/or polydiallyldimethylammonium chloride. The document gives no indication regarding the stability and the conductivity of the sols produced.

WO-2012/055758 discloses a process for preparing metal particles doped with a foreign element in order to achieve electrical conductivity at low sintering temperatures. In one inventive example an Ag sol was produced which exhibited a conductivity of 4.4 E+06 S/m after one hour at 140° C. A comparative specimen without RuO₂ doping achieved a specific conductivity of 1 S/m after one hour at 140.

The US-2006/044384 application describes the use of random and terpolymers of methacrylic acid and polyethylene glycol methacrylate (PEGMA). Hydroxyl-terminated PEGMA having a molar weight of 256 g/mol or 360 g/mol are employed in examples. Paragraph [0009] intimates that the nonionic proportion should have a chain length below 1000 g/mol. The reduction to elemental silver is effected with toxic hydrazine. Ag sols having a concentration of up to 30 wt % are produced. 10 to 100 wt % (based on silver) of dispersant are required to ensure sufficient stability of the particles. Electrical conductivity was detected but neither the parameters (layer thickness, temperature) nor a unit were disclosed. The storage stability of the particles produced was not investigated.

All described processes for producing nano- and submicroscale metal particles have decisive disadvantages. Thus for example the described process cannot be reproduced on an industrial scale or the particles produced have a very high dispersant loading. If the particles are intended to generate electrical conductivity the sintering takes place only at relatively high temperatures of at least 140° C. and is therefore not suitable for application on temperature-sensitive polymeric substrates.

It is accordingly an object of the following invention to find a dispersant which allows industrial-scale production of highly concentrated metal dispersions and ensures a high colloid-chemical stability even during storage at up to 60° C. After a coating process and a thermal or photonic treatment the thus produced dispersions should become electrically conducting even at relatively low temperatures of from 90° C. and should therefore be applicable for temperature-sensitive plastic substrates. It is a further goal to generate a better conductivity than the prior art while retaining identical sintering temperatures and times.

As has now been found, surprisingly, copolymers based on mixedly alkoxylated (meth)acrylic acid derivatives and acrylic monomers are very well suited as dispersants for producing nanoscale metal particles. Compared to known homogeneously alkoxylated methacrylic acid derivatives the aqueous nanoscale metal dispersions produced with the copolymer according to the invention exhibit a markedly better storage stability at room temperature, in particular at up to 60° C. However, at elevated temperatures a reversal in stability is surprisingly found which has the result that the particles produced with the polymers according to the invention undergo sintering above a temperature as low as 90° C.

This makes it possible for example to achieve good conductivity values even at low sintering temperatures of at least 1.8 E06 S/m, in particular of 2.0 E06 S/m at 90° C., at least 2.9 E06 S/m, in particular 3.1 E06 S/m at 110° C. and at least 5.2 E06 S/m, in particular 5.4 at 130° C. The metal dispersions according to the invention thus also allow for use of temperature-sensitive substrates as printing stock while nevertheless achieving good conductivities which has not hitherto been possible with the known metal dispersions.

This makes the use of temperature-sensitive substrates possible. Improved electrical conductivity coupled with reduced demands on time can likewise be achieved.

The present invention achieves the object and accordingly relates to metal dispersions comprising, as the dispersant, copolymers comprising 1-99 wt % of structural units of formula (1),

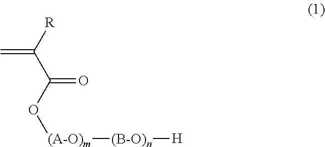

where
R is hydrogen or C₁-C₆ alkyl,
A is C₂-C₄ alkylene group and
B is C₂-C₄ alkylene group with the proviso that A and B are different and
m, n are each independently an integer of 1-200, and
1-99 wt % of structural units of formula (2),

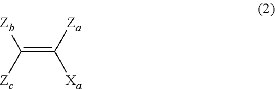

where
Xₐ is an aromatic or aliphatic radical having 1 to 30 carbon atoms which optionally comprises one or more, for example 1, 2, or 3, heteroatoms N, O and S,
Zₐ is H or (C₁-C₄)-alkyl,
Z_{b} is H or (C₁-C₄)-alkyl and
Z_{c} is H or (C₁-C₄)-alkyl.

The embodiments of the invention described hereinbelow relate to the use:
R is in a preferred embodiment of the invention hydrogen or methyl.
A and B are C₂-C₄ alkylene groups with the proviso that A and B are not identical. This means that the structural units of formula (1) may be alkoxylated with up to 200 C₂-C₄-alkoxy units, wherein a blockwise alkoxylation with at least two of ethylene oxide, propylene oxide or butylene oxide or a (random) mixed alkoxylation with at least two of ethylene oxide, propylene oxide or butylene oxide may be concerned.

It is preferable when A and B are an ethylene or propylene group. It is particularly preferable when A is a propylene group and B is an ethylene group. Specifically, A is a propylene group and B is an ethylene group wherein m=2 to 7 and n=50 to 200, preferably m=2 to 6 and n=50 to 200, very preferably m=3 to 6 and n=50 to 200.

The macromonomers based on structural units of formula (1) are obtainable by polymerization of alkoxylated acrylic or methacrylic acid derivatives (the term acrylic acid is hereinbelow to be understood as also encompassing methacrylic acid). These are obtainable by alkoxylation of acrylic acid or 2-alkylacrylic acid or acrylic monoesters of ethylene glycol, propylene glycol or butylene glycol (2-hydroxyethyl acrylate, 2-hydroxypropyl acrylate or 2-hydroxybutyl acrylate) or 2-alkylacrylic monoesters of ethylene glycol, propylene glycol or butylene glycol (2-hydroxyethyl 2-alkylacrylate, 2-hydroxypropyl 2-alkylacrylate or 2-hydroxybutyl 2-alkylacrylate).

The alkoxylated acrylic acid derivatives are particularly preferably produced by DMC-catalyzed alkoxylation of 2-hydroxypropyl acrylate or 2-hydroxypropyl 2-alkylacrylate, specifically by DMC-catalyzed alkoxylation of 2-hydroxypropyl 2-methacrylate. In contrast to traditional alkali-catalyzed alkoxylation, DMC catalysis allows a very selective synthesis of monomers with precisely defined properties avoiding unwanted by-products. DE-102006049804 and U.S. Pat. No. 6,034,208 teach the advantages of DMC catalysis.

The following list contains preferred synthesis examples analogous to the above synthesis prescription:

It is preferable when the composition of the structural units of formula (1) corresponds to at least one of the following polyglycols:

| | |
|---|---|
| polyglycol 1 | polyalkylene glycol methacrylate (formula (1), m = 2, |
| | n = 12-13; (A-O) is [CH₂CH(CH₃)O)]; (B-O) is |
| | (CH₂CH₂O)); molar mass about 750 g/mol |
| polyglycol 2 | polyalkylene glycol methacrylate (formula (1), m = 2, |
| | n = 17-19; (A-O) is [CH₂CH(CH₃)O)]; (B-O) is |
| | (CH₂CH₂O)); molar mass about 1000 g/mol |
| polyglycol 3 | polyalkylene glycol methacrylate (formula (1), m = 5, |
| | n = 38-40; (A-O) is [CH₂CH(CH₃)O)]; (B-O) is |
| | (CH₂CH₂O)); molar mass about 2000 g/mol |
| polyglycol 4 | polyalkylene glycol methacrylate (formula (1), m = 5, |
| | n = 95-105; (A-O) is [CH₂CH(CH₃)O)]; (B-O) is |
| | (CH₂CH₂O)); molar mass about 5000 g/mol |
| polyglycol 5 | polyalkylene glycol methacrylate (formula (1), m = 5, |
| | n = 190-200; (A-O) is [CH₂CH(CH₃)O)]; (B-O) is |
| | (CH₂CH₂O)); molar mass about 12 000 g/mol |

Suitable structural units of formula (2) are preferably those derived from styrenesulfonic acid, acrylamidomethylpropanesulfonic acid (AMPS), vinylsulfonic acid, vinylphosphonic acid, allylsulfonic acid, methallylsulfonic acid, acrylic acid, methacrylic acid and maleic acid or the anhydride thereof, and the salts of the aforementioned acids with mono- and divalent counterions, and also 2-vinylpyridine, 4-vinylpyridine, vinylimidazole, vinyl acetate, glycidyl methacrylate, acrylonitrile, tetrafluoroethylene and DADMAC. Further examples that may be mentioned include N-vinylformamide, N-vinylmethylformamide, N-vinylmethylacetamide, N-vinylacetamide, N-vinylpyrrolidone (NVP), 5-methyl-N-vinylpyrrolidone, N-vinylvalerolactam and N-vinylcaprolactam. In a preferred embodiment the structural units of formula (2) derive from N-vinylimidazole, N-vinylpyrrolidone, N-vinylcaprolactam, acrylic acid and methacrylic acid.

The polymers to be used in accordance with the invention comprise for example 99 to 70, preferably 95 to 75, in particular 90 to 80, wt % of structural units of formula (1).

In a preferred embodiment the structural units of formula (1) and the structural units of formula (2) add up to 100%.

Production of the polymers to be used in accordance with the invention is effected by free-radical polymerization of the monomers using a suitable free-radical starter at temperatures between 50 and 150° C. The molecular weight of these polymers may vary in the range from 6000 to 1×10⁶ g/mol, preferably 15 000 to 800 000, with molecular weights between 20 000 and 600 000 g/mol being very preferred however.

Suitable alcoholic solvents include water-soluble mono- or dialcohols, for example propanol, butanol, ethylene glycol and also ethoxylated monoalcohols such as butyl glycol, isobutyl glycol and butyl diglycol. However, it is also possible to use water alone as solvent. After the polymerization generally clear solutions are formed.

The thus produced dispersant solutions may also comprise other substances, for example biocides, UV stabilizers, antioxidants, metal deactivators, IR absorbers, flame retardants and the like in an amount of 0.01-1.0 wt %, preferably 0.01-0.5 wt % and very preferably 0.1-0.25 wt %.

In a preferred embodiment the nanoscale metal particles are produced in continuous fashion in a microreaction plant as per WO 2007/118669, paragraphs [0027] to [0056]. The thus obtained metal particle sols were purified by means of membrane filtration and concentrated to a solids content of silver particles of 50-80 wt %, preferably 51-79 wt % and particularly preferably 52-78 wt %. The particle size of the silver particles is preferably between 5 and 100 nm in at least one dimension. The dispersant content is 1-9 wt %, preferably 2-8 wt % and particularly preferably 3-7 wt %. A transmission electron micrograph of a sample of silver nanoparticles produced in accordance with the invention and the corresponding particle size distribution by volume is shown in FIGS. (1) and (2).

### EXAMPLES

The synthesis of the copolymers is effected as follows: A flask equipped with a stirrer, reflux cooler, internal thermometer and nitrogen inlet is initially charged, in the weight fractions reported in the following table, with the polyglycol of formula (1) and the acrylic monomer of formula (2) and also a molecular weight regulator in solvent while nitrogen is introduced. The temperature is then brought to 80° C. with stirring and a solution of the initiator is metered in over one hour. The mixture is stirred at this temperature for a further two hours. Further additives may be metered in subsequently. The composition of the copolymers is summarized in the following table.

TABLE 1
Inventive copolymers

| | example | 1 | 2 | 3 | 4 | 5 | 6 | 7 | 8 | 9 | 10 |
|---|---|---|---|---|---|---|---|---|---|---|---|
| monomer 1 | polyglycol 1 (M_{w} = 750 g/mol) | 67.7 | 67.7 | 62.5 | 59.8 | | | | | | |
| | polyglycol 2 (M_{w} = 1000) | | | | | 62.4 | 62.4 | 57.7 | 59.7 | | |
| | polyglycol 3 (M_{w} = 2000) | | | | | | | | | 67.7 | 67.7 |
| | polyglycol 4 (M_{w} = 5000) | | | | | | | | | | |
| | polyglycol 5 (M_{w} = 12 000) | | | | | | | | | | |
| monomer 2 | methacrylic acid | 1.9 | 3.8 | | | | 6.0 | 3.9 | | 3.9 | 1.9 |
| | acrylic acid | | | 4.0 | 4.1 | 6.0 | | | 10 | | |
| | vinylimidazole | 1.9 | | | | | 2.0 | 5.9 | | | |
| | vinylpyrrolidone | | | | | 2.0 | | | | | 1.9 |
| | vinylcaprolactam | | | 4.0 | 4.1 | | | | | | |
| | benzyl methacrylate | | | | | | | | 3.9 | | |
| | isobornyl methacrylate | | | | | | | | | | |
| | 2-ethylhexyl methacrylate | | | | 2.0 | | | | | | |
| | phenoxyethyl methacrylate | | | | | | | | | | |
| initiator | sodium peroxodisulfate | 3.1 | 2.2 | 2.3 | 2.3 | 2.3 | 2.3 | 2.6 | 2.6 | 2.2 | 2.2 |
| regulator | mercaptopropionic acid | 0.4 | 0.4 | 0.4 | 0.4 | 0.4 | 0.4 | 0.5 | 0.5 | 0.4 | 0.4 |
| solvent | water | | 25.0 | 26.8 | | 26.9 | | | | 25.8 | |
| | butyl glycol | 24.9 | | | 26.85 | | 26.9 | 29.4 | 29.4 | | 25.8 |
| additive | 1,2-benzisothiazol-3(2H)-one | 0.1 | | | 0.15 | | | | | | |

TABLE 2
Inventive copolymers

| | example | 11 | 12 | 13 | 14 | 15 | 16 | 17 | 18 | 19 | 20 |
|---|---|---|---|---|---|---|---|---|---|---|---|
| monomer 1 | polyglycol 1 (M_{w} = 750 g/mol) | | | | | | | | | | |
| | polyglycol 2 (M_{w} = 1000) | | | | | | 4.0 | | | | |
| | polyglycol 3 (M_{w} = 2000) | 62.7 | 60.2 | | | | | | | | |
| | polyglycol 4 (M_{w} = 5000) | | | 65.8 | 67.7 | 63.7 | 63.7 | | | | |
| | polyglycol 5 (M_{w} = 12 000) | | | | | | | 67.7 | 62.4 | 62.6 | 62.5 |
| monomer 2 | methacrylic acid | 8 | 2.9 | 3.9 | 3.9 | | | | 8.0 | 4.0 | |
| | acrylic acid | | 2.9 | | | | 2.0 | 4.9 | | | 4.0 |
| | vinylimidazole | | 2.1 | | | 3.9 | | | | | |
| | vinylpyrrolidone | | | 1.9 | | | | | | | |
| | vinylcaprolactam | | | | | | | | | 4.0 | |
| | benzyl methacrylate | | | | | | | | | | 4.0 |
| | isobornyl methacrylate | | | | | | 4.0 | | | | |
| | 2-ethylhexyl methacrylate | | | | | 6 | | | | | |
| | phenoxyethyl methacrylate | | 2.1 | | | | | | | | |
| initiator | sodium peroxodisulfate | 2.3 | 2.4 | 2.2 | 2.2 | 2.2 | 2.2 | 2.2 | 2.3 | 2.3 | 2.3 |
| regulator | mercaptopropionic acid | 0.4 | 0.4 | 0.4 | 0.4 | 0.4 | 0.4 | 0.4 | 0.4 | 0.4 | 0.4 |
| solvent | water | 26.6 | | | 25.9 | 25.9 | 23.6 | | | 26.7 | |
| | butyl glycol | | 26.9 | 25.8 | | | | 24.8 | 26.9 | | 26.8 |
| additive | 1,2-benzisothiazol-3(2H)-one | | 0.1 | | | | 0.1 | | | | |

### Production of Metal Nanoparticles:

The nanoscale metal particles were produced in continuous fashion in a microreaction plant as per EP-2010314, paragraphs [0027] to [0056]. The thus obtained metal particle sols were purified by means of membrane filtration and concentrated to a metal content of 50-80 wt %. The dispersant content was determined as 1-9 wt %.

TABLE 3
Silver content and dispersant content

| | | content of | |
|---|---|---|---|
| | silver | dispersant and | water |
| example based | content | additive | content |
| on copolymer | [wt %] | [wt %] | [wt %] |
| 1 | 57.8 | 3.9 | 38.3 |
| 2 | 58.1 | 4.0 | 37.9 |
| 3 | 56.2 | 3.1 | 40.7 |
| 4 | 56.4 | 4.8 | 38.3 |
| 5 | 53.2 | 3.2 | 43.6 |
| 6 | 54.8 | 3.3 | 41.9 |
| 7 | 54.1 | 2.2 | 43.7 |
| 8 | 58.2 | 3.0 | 38.8 |
| 9 | 57.8 | 3.4 | 38.8 |
| 10 | 57.0 | 3.3 | 39.7 |
| 11 | 78.9 | 6.8 | 14.3 |
| 12 | 73.6 | 6.3 | 20.1 |
| 13 | 55.3 | 3.1 | 41.6 |
| 14 | 58.7 | 3.8 | 37.5 |
| 15 | 54.1 | 5.1 | 40.8 |
| 16 | 59.8 | 4.0 | 36.2 |
| 17 | 67.5 | 5.1 | 27.4 |
| 18 | 68.4 | 5.6 | 26.0 |
| 19 | 58.2 | 5.0 | 36.8 |
| 20 | 56.8 | 3.8 | 39.4 |
| comparison 1 | 16.1 | 12.5 | 71.4 |
| (US-2006044384 “A”) | | | |
| comparison 2 | 19.2 | 11.5 | 69.3 |
| (US-2006044384 “G”) | | | |
| comparison 3 | 8 | 2.3 | 89.7 |
| (WO-2012/055758) | | | |
| comparison 4 | 3.1 | 18.3 | 78.6 |
| (U.S. Pat. No. 8,227,022) | | | |

For comparison, metal nanoparticles were produced as per US-20060044382 (Lexmark, example A [0019] and example G [0023]), WO-2012/055758 (Bayer Technology Services/BTS, example 1) and U.S. Pat. No. 8,227,022 and included as comparative examples 1, 2, 3 and 4.

### Test Results

The silver sols obtained were stored at room temperature and the solids content of the dispersion (=sum of silver and dispersant content) was determined at intervals of 4, 8 and 16 weeks without stirring of the sample. A reduction in the solids content points to sedimentation of the silver particles and thus to a lower stability of the dispersion.

TABLE 4
Storability at room temperature

| | solids | solids | solids |
|---|---|---|---|
| | content | content | content |
| Ag sol | after 4 weeks | after 8 weeks | after 16 weeks |
| based on | of storage | of storage | of storage |
| copolymer | [wt %] | [wt %] | [wt %] |
| 1 | 61.5 | 61.3 | 61.6 |
| 2 | 62.0 | 62.3 | 61.8 |
| 3 | 59.3 | 59.0 | 58.9 |
| 4 | 61.0 | 61.2 | 61.0 |
| 5 | 56.5 | 56.3 | 56.2 |
| 6 | 57.8 | 57.9 | 57.8 |
| 7 | 56.3 | 56.3 | 56.1 |
| 8 | 61.0 | 61.4 | 61.0 |
| 9 | 60.8 | 61.0 | 61.2 |
| 10 | 60.5 | 60.2 | 59.8 |
| 11 | 78.6 | 78.7 | 78.5 |
| 12 | 73.5 | 73.7 | 73.5 |
| 13 | 58.4 | 58.1 | 58.0 |
| 14 | 62.3 | 62.6 | 62.6 |
| 15 | 59.3 | 59.3 | 59.1 |
| 16 | 63.5 | 63.4 | 63.3 |
| 17 | 67.2 | 67.1 | 66.8 |
| 18 | 68.4 | 68.2 | 67.9 |
| 19 | 63.5 | 63.3 | 63.2 |
| 20 | 60.1 | 60.1 | 59.8 |
| comparison 1 | 25.2 | 20.3 | 12.8 |
| (US-2006044384 “A”) | | | |
| comparison 2 | 27.3 | 22.1 | 13.1 |
| (US-2006044384 “G”) | | | |
| comparison 3 | 7.8 | 6.5 | 4.1 |
| (WO-2012055758 “1”) | | | |
| comparison 4 | 20.2 | 19.9 | 19.3 |
| (U.S. Pat. No. 8,227,022) | | | |

As is apparent from the above table all silver sols based on the inventive polymers exhibit a markedly higher stability at room temperature than the prior art silver sols (comparison 1-4).

For electrical testing the metal sols obtained were applied by spin-coating to an 18×18 mm glass sheet in a layer thickness between 0.1 and 10 μm, preferably between 0.5 and 5 μm. The glass plate was then subjected to thermal sintering at a defined temperature for 60 minutes in each case and surface resistance was measured by the four point method in [Ohm/square]. After determination of the layer thickness specific conductivity in [S/m] was determined.

TABLE 5
specific conductivity

| | conductivity | conductivity | conductivity |
|---|---|---|---|
| | after | after | after |
| Ag sol | sintering | sintering | sintering |
| based on | at 90° C. | at 110° C. | at 130° C. |
| copolymer | [E06 S/m] | [E06 S/m] | [E06 S/m] |
| 1 | 3.5 | 3.9 | 5.2 |
| 2 | 3.8 | 4.1 | 5.3 |
| 3 | 3.7 | 4.3 | 5.6 |
| 4 | 2.5 | 2.9 | 6.0 |
| 5 | 2.7 | 4.0 | 5.8 |
| 6 | 2.3 | 4.2 | 5.5 |
| 7 | 1.8 | 4.2 | 5.7 |
| 8 | 2.5 | 4.4 | 5.6 |
| 9 | 3.8 | 6.1 | 6.3 |
| 10 | 4.2 | 5.9 | 6.9 |
| 11 | 6.4 | 8.3 | 9.2 |
| 12 | 6.1 | 8.2 | 9.0 |
| 13 | 3.7 | 4.2 | 7.0 |
| 14 | 5.1 | 6.9 | 7.8 |
| 15 | 5.3 | 6.5 | 8.0 |
| 16 | 4.9 | 6.1 | 7.4 |
| 17 | 5.7 | 7.6 | 8.1 |
| 18 | 4.4 | 7.7 | 8.0 |
| 19 | 4.3 | 7.3 | 7.4 |
| 20 | 4.5 | 6.9 | 8.0 |
| comparison 1 | 0 | 0 | 0 |
| (US-2006044384 “A”) | | | |
| comparison 2 | 0 | 0 | 0 |
| (US-2006044384 “G”) | | | |
| comparison 3 | 0 | 0 | 4.4 (140° C.) |
| (WO-2012055758 “1”) | | | |
| comparison 4 | 2.0 (100° C.) | not specified | 2.6 (150° C.) |
| (U.S. Pat. No. 8,227,022) | | | |
| comparison 5 | not specified | not specified | 2.3 (210° C.) |
| (Xerox) | | | |

As is apparent from the above table all silver sols produced with the polymers according to the invention exceed the electrical conductivity of the comparative products after thermal sintering both with the absolute value and with the beginning of the sintering temperature. This means that a reduced energy input is required to achieve comparable electrical conductivity in the end product. This also widens the range of thermally sensitive substrates that may be used as printing stock.

1. A metal dispersion comprising 50 to 80 wt % of silver nanoparticles, 15 to 45 wt % of water and a dispersant, wherein the dispersant comprises copolymers having 1-99 wt % of structural units of formula (1), 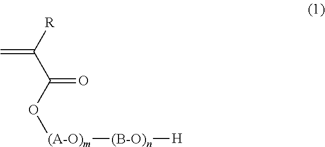
wherein
R is hydrogen or C₁-C₆ alkyl,
A is a C₂-C₄ alkylene group and
B is a C₂-C₄ alkylene group with the proviso that A and B are different and
m, n are each independently an integer of 1-200, and
1-99 wt % of structural units of formula (2), 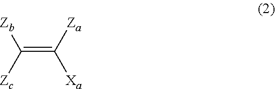
wherein
Xₐ is an aromatic or aliphatic radical having 1 to 30 carbon atoms, optionally comprising one or more heteroatoms N, O and S,
Zₐ is H or (C₁-C₄)-alkyl,
Z_{b} is H or (C₁-C₄)-alkyl and
Z_{c} is H or (C₁-C₄)-alkyl.

2. The metal dispersion as claimed in claim 1, wherein A and/or B are an ethylene or propylene group or A is a propylene group and B is an ethylene group or A is a propylene group and B is an ethylene group.

3. The metal dispersion as claimed in claim 1, wherein m=2 to 7 and n=50 to 200.

4. The metal dispersion as claimed in claim 1, further comprising a solvent selected from the group consisting of water-soluble mono-alcohols, water-soluble dialcohols, and ethoxylated monoalcohols.

5. The metal dispersion as claimed in claim 1, wherein the composition of the structural units of formula (1) corresponds to at least one of the following polyglycols:

| | |
|---|---|
| polyglycol 1 | polyalkylene glycol methacrylate (formula (1), m = 2, |
| | n = 12-13; (A-O) is [CH₂CH(CH₃)O)]; (B-O) is |
| | (CH₂CH₂O)); molar mass about 750 g/mol |
| polyglycol 2 | polyalkylene glycol methacrylate (formula (1), m = 2, |
| | n = 17-19; (A-O) is [CH₂CH(CH₃)O)]; (B-O) is |
| | (CH₂CH₂O)); molar mass about 1000 g/mol |
| polyglycol 3 | polyalkylene glycol methacrylate (formula (1), m = 5, |
| | n = 38-40; (A-O) is [CH₂CH(CH₃)O)]; (B-O) is |
| | (CH₂CH₂O)); molar mass about 2000 g/mol |
| polyglycol 4 | polyalkylene glycol methacrylate (formula (1), m = 5, |
| | n = 95-105; (A-O) is [CH₂CH(CH₃)O)]; (B-O) is |
| | (CH₂CH₂O)); molar mass about 5000 g/mol |
| polyglycol 5 | polyalkylene glycol methacrylate (formula (1), m = 5, |
| | n = 190-200; (A-O) is [CH₂CH(CH₃)O)]; (B-O) is |
| | (CH₂CH₂O)); molar mass about 12 000 g/mol. |

6. The metal dispersion as claimed in claim 1, wherein the structural units of formula (2) derive from N-vinylimidazole, N-vinylpyrrolidone, N-vinylcaprolactam, acrylic acid or methacrylic acid.

7. The metal dispersion as claimed in claim 1, wherein the dispersion comprises 1-9 wt % of the dispersant.

8. The metal dispersion as claimed in claim 1, wherein the dispersion comprises additives in an amount of 0.1 to 1.0 wt %.

9. The metal dispersion as claimed in claim 1, wherein the particle size of the silver nanoparticles is between 5 and 100 nm in at least one dimension.

10. The metal dispersion as claimed in claim 1, wherein conductivity values of at least 1.8 E06 S/m are achieved by sintering at temperatures of 90° C.

11. A dispersant for stabilizing metal dispersions comprising 1-99 wt % of structural units of formula (1), 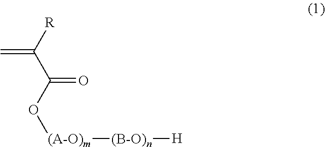
wherein
R is hydrogen or C₁-C₆ alkyl,
A is a C₂-C₄ alkylene group and
B is a C₂-C₄ alkylene group with the proviso that A and B are different and
m, n are each independently an integer of 1-200, and
1-99 wt % of structural units of formula (2), 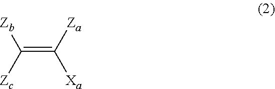
wherein
Xₐ is an aromatic or aliphatic radical having 1 to 30 carbon atoms, optionally comprising one or more heteroatoms N, O and S,
Zₐ is H or (C₁-C₄)-alkyl,
Z_{b} is H or (C₁-C₄)-alkyl and
Z_{c} is H or (C₁-C₄)-alkyl.

12. A method for producing a composition comprising the step of adding a metal dispersion as claimed in claim 1 to the composition during the manufacture of the composition, wherein the composition is selected from the group consisting of inks, paints, coatings and graphic printed matter.

13. A method for producing an electrically conductive coating comprising the step of adding a metal dispersion as claimed in claim 1 to the electrically conductive coating during the manufacture of the electrically conductive coating.

14. An ink, paint, coating or graphic printed matter comprising a metal dispersion as claimed in claim 1.

15. An electrically conductive coating comprising a metal dispersion as claimed in claim 1.
